(19) United States
(12) Patent Application Publication
(10) Pub. No.: US 2012/0260013 A1
(43) Pub. Date: Oct. 11, 2012

(54) KVM switcher (Multi-computer switcher) with integrated parallel transmission, serial peripheral interface and universal serial bus

(75) Inventor: Chun Tse LIN, New Taipei City (TW)

(73) Assignee: OCT Technology Co.,Ltd.

(21) Appl. No.: 13/080,679

(22) Filed: Apr. 6, 2011

(51) Int. Cl. G06F 13/14

(52) U.S. Cl. 710/110

(57) ABSTRACT

A KVM switcher (multi-computer switcher) with integrated parallel transmission, serial peripheral interface (SPI), and universal serial bus (USB), characterized in that signals are transmitted through a parallel transmission interface between a SPI master control unit and at least one USB host interface control unit.

### BACKGROUND OF THE INVENTION

1. Technical Field

The present invention relates to a KVM switcher (multi-computer switcher) with integrated parallel transmission, serial peripheral interface (SPI), and universal serial bus (USB), especially to a KVM switcher (multi-computer switcher) with the use of SPI to control the data flow between the integrated parallel transmission interface and the USB.

2. Description of the Related Art

The conventional KVM (Keyboard/Video/Mouse, KVM) switcher can switch and share a group of peripheral devices, including a keyboard, a mouse, a screen, or even a microphone, a speaker, an USB disk, a storage device, and any peripheral devices with universal serial bus (USB) interface, among plural computers, so that users can control plural computers or share resources through only one group of peripheral devices prepared, by way of selecting and switching by the KVM switcher from the connections between the peripheral devices and computers.

In the conventional KVM switcher, an USB switching system is constituted by a control unit and an USB hub, so as to connect signals from an USB host interface control unit of a keyboard, a mouse, and the like, through serial transmission in the USB hub. Compared with serial transmission, parallel transmission has an advantage of faster transmission speed, however, the parallel transmission is not applied to the USB switching system in the KVM switcher.

On the other hand, the conventional serial peripheral interface, which is abbreviated to “SPI”, is a four-line synchronous serial data communication protocol, and employs the master-slave architecture; under such architecture, the SPI device is classified as SPI master device and SPI slave device. Generally, one SPI master device combines with plural SPI slave devices, and the plural SPI slave devices are controlled by the SPI master device. The SPI master device sends a control signal and selects which SPI slave devices should receive data, when communication. The SPI not only has the advantage of full-duplex, but also performs communication with high bandwidth and synchronous signals. In addition, there also are characteristics of brief circuit, simple control and easy operation.

In spite of many advantages of the conventional SPI, which are suitable for the switching system, but are not applied to the USB switching system of the KVM switcher.

The conventional technique has the following disadvantages:

1. In the conventional KVM switcher, the USB switching system is constituted by the control unit and the USB hub, and signals are transmitted through serial transmission, not through parallel transmission;

2. Because of the serial transmission in the conventional USB switching system, the transmission speed is slow and thus the response time of operation for the keyboard and mouse is affected; and

3. The conventional USB switching system does not employ the SPI communication protocol, therefore, the advantages of SPI, including full-duplex, high bandwidth, brief circuit, and simple control, do not exist.

Accordingly, the present invention concerns to overcome the above disadvantages in the conventional technique, such as effectively shortening the response time of operation for the keyboard and mouse in the USB switching system, and performing the switching function of the USB device through the SPI communication protocol.

### SUMMARY OF THE INVENTION

A KVM switcher (multi-computer switcher) with integrated parallel transmission, serial peripheral interface (SPI), and universal serial bus (USB) includes:

a SPI master control unit, with a SPI master device interface and a parallel transmission interface;

at least one USB host interface control unit, with an USB interface for connecting the peripheral device of the USB interface, and a parallel transmission interface and a SPI slave device interface for connecting the SPI master device interface of the SPI master control unit, in which the parallel transmission interface of the USB host interface control unit selectively and electrically connects the parallel transmission interface of the SPI master control unit; and

at least one USB device control unit, with an USB interface for connecting at least one USB interface of a computer or at least one USB hub, and a SPI slave device interface for electrically connecting the SPI master device interface of the SPI master control unit;

characterized in that signals are transmitted through the parallel transmission interface between the SPI master control unit and the at least one USB host interface control unit;

wherein the SPI master control unit can switch and select a specific USB device control unit among the at least one USB device control unit, and assign the signal of the at least one USB device control unit to the specific USB device control unit; and the SPI master control unit directly controls the connected SPI slave device through the SPI master device interface to achieve the switch operation;

wherein signals transmitted between the SPI master control unit and the at least one USB device control unit through the SPI interface;

wherein the peripheral device of the at least USB interface is a keyboard with USB interface or a mouse with USB interface;

wherein the at least one USB hub electrically connects the at least one USB device control unit, respectively, and the at least one USB device control unit indirectly electrically connects the corresponding computers through the at least one USB hub;

wherein an USB switch is further included, electrically connects the SPI master control unit and the at least one device with USB interface, and is controlled by the SPI master control unit, to assign the signal of the device with USB interface to the plural USB hubs;

wherein the device with USB interface is a storage device with USB interface; and

wherein the SPI master control unit can mutually transfer the signals between the parallel transmission interface and the SPI master device interface.

### BRIEF DESCRIPTION OF THE DRAWINGS

FIG. 1 is a functional block schematic view, showing an embodiment of a KVM switcher (multi-computer switcher) with integrated parallel transmission, serial peripheral interface (SPI), and universal serial bus (USB) according to the present invention; and

FIG. 2 is an actual use schematic view, showing an embodiment of a KVM switcher (multi-computer switcher) with integrated parallel transmission, serial peripheral interface (SPI), and universal serial bus (USB) according to the present invention.

### DETAILED DESCRIPTION OF THE INVENTION

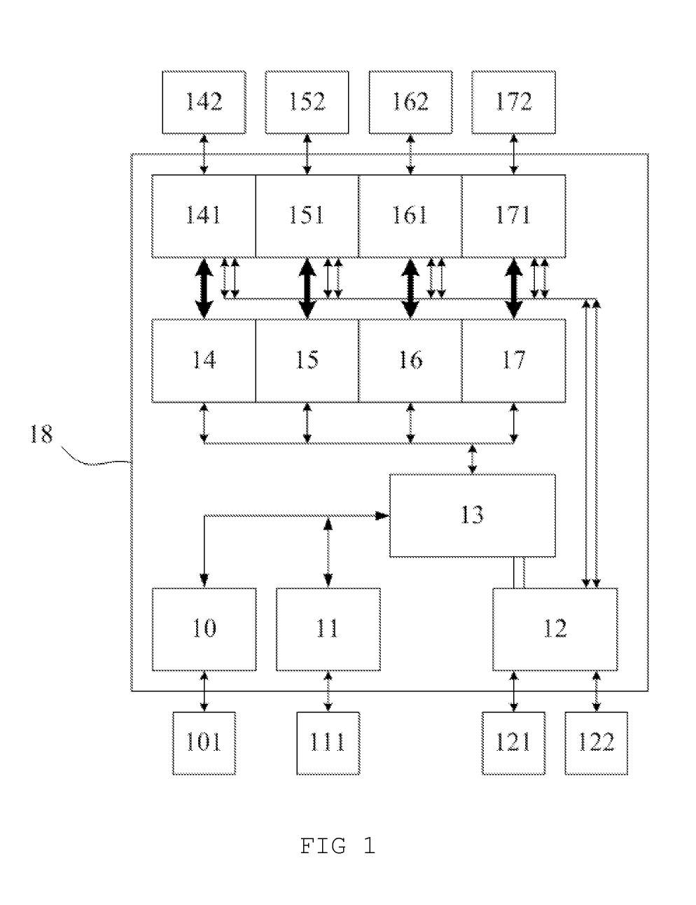

FIG. 1 is a functional block schematic view, showing an embodiment of a KVM switcher (multi-computer switcher) with integrated parallel transmission, serial peripheral interface (SPI), and universal serial bus (USB) according to the present invention, including USB host interface control units 10 and 11, a keyboard with USB interface 101, a mouse with USB interface 111, an USB switch 12, storage device with USB interfaces 121 and 122, a SPI master control unit 13, USB device control units 14, 15, 16 and 17, USB hubs 141, 151, 161 and 171, computers 142, 152, 162 and 172, and an USB switching system 18. In the KVM switcher 18 (multi-computer switcher) with integrated parallel transmission, serial peripheral interface (SPI), and universal serial bus (USB) of the present invention, the USB host interface control unit 10 electrically connects the keyboard with USB interface 101; the USB host interface control unit 11 electrically connects the mouse with USB interface 111, and the like. The USB device control units 14, 15, 16 and 17 electrically connect the USB hubs 141, 151, 161 and 171, respectively, and the USB hubs 141, 151, 161 and 171 connect the computers 142, 152, 162 and 172, respectively. The USB host interface control units 10 and 11 and the SPI master control unit 13 are all equipped with parallel transmission interfaces, and electrically connect with each other through the same. The SPI master control unit 13 and the USB device control units 14, 15, 16 and 17 are all equipped with SPI interfaces, and electrically connect with each other through the same, in which the SPI master control unit 13 has the SPI master device interface, and the USB device control units 14, 15, 16 and 17 have the SPI slave device interfaces. Thereby, the SPI master control unit 13 can control to selectively assign the signals of the USB host interface control units 10 and 11 to any one of the USB device control units 14, 15, 16 and 17 through the SPI communication protocol of the SPI master device interface, and can mutually transfer the signals between the parallel transmission interface and the SPI master device interface. For example, by way of the SPI communication protocol, the SPI master control unit 13 controls to assign the signals from the USB host interface control units 10 and 11, which are transmitted through the parallel transmission interface, to the USB device control unit 14, whereby the signals from the keyboard with USB interface 101 and the mouse with USB interface 111, which connect the USB host interface control units 10 and 11, can be transmitted to the SPI master control unit 13 through the parallel peripheral interface, then transmitted to the USB device control unit 14 through the SPI, and then transmitted to the computer 142 through the USB hub 141, and whereby the keyboard with USB interface 101 and the mouse with USB interface 111 can control the computer 142. Of course, the SPI master control unit 13 also can assign the signals from the USB host interface control units 10 and 11 to the other of the USB device control units 15, 16 and 17, in the above manner.

The USB switch 12 can connect the device with USB interface, such as the storage devices 121 and 122, the USB hubs 141, 151, 161 and 171, or the like, and the USB switch 12 electrically connects the SPI master control unit 13 and the USB hubs 141, 151, 161 and 171. The USB switch 12 is controlled by the SPI master control unit 13, so as to assign the signals from the storage devices with USB interface 121 and 122, which connect the USB switch 12, to the USB hubs 141, 151, 161 and 171. Certainly, the signals from the storage devices with USB interface 121 and 122, which connect the USB switch 12, also can be assigned to the other of the USB hubs 141, 151, 161 and 171, for example, the signal of the storage device with USB interface 121 is assigned to the USB hub 141, and the signal of the storage device with USB interface 122 is assigned to the USB hub 151. Thereby, the computer 142 accesses the storage device with USB interface 121, and the computer 152 accesses the storage device with USB interface 122.

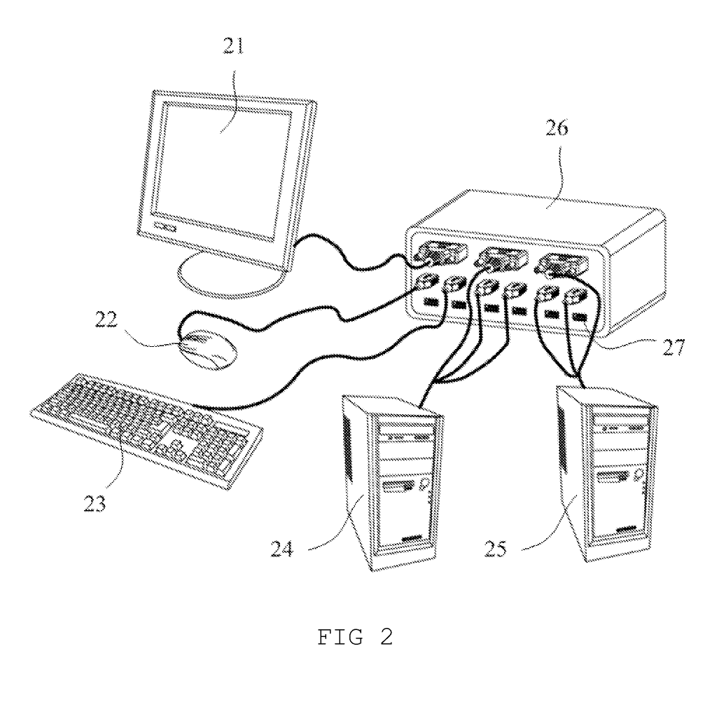

FIG. 2 is an actual use schematic view, showing an embodiment of a KVM switcher (multi-computer switcher) with integrated parallel transmission, serial peripheral interface (SPI), and universal serial bus (USB) according to the present invention, including a screen 21, a mouse with USB interface 22, a keyboard with USB interface 23, computers 24 and 25, a KVM switcher 26, and an USB interface 27. On the KVM switcher 26, there are plural display interfaces and the USB interface 27. The peripheral devices, such as the screen 21, the mouse 22 and the keyboard 23, electrically connect the KVM switcher 26, and the KVM switcher 26 has the corresponding transmission line connecting the computers 24 and 25, for individual peripheral device.

In the KVM switcher 26, a KVM switcher (multi-computer switcher) with integrated parallel transmission, serial peripheral interface (SPI), and universal serial bus (USB) is provided, thus the mouse with USB interface 22 and the keyboard with USB interface 23 electrically connect the USB host interface control unit in the KVM switcher (multi-computer switcher) with integrated parallel transmission, serial peripheral interface (SPI), and universal serial bus (USB); and the transmission line connecting the computers 24 and 25 connects the USB hub, whereby the switching function for the peripheral device, such as the keyboard and mouse, is realized.

The present invention has the following advantages:

1. The KVM switcher (multi-computer switcher) with integrated parallel transmission, serial peripheral interface (SPI), and universal serial bus (USB) according to the present invention transmits the peripheral signals for the keyboard and mouse through parallel transmission, therefore, the faster transmission speed can effectively shorten the response time of operation for the keyboard and mouse; and

2. The KVM switcher (multi-computer switcher) with integrated parallel transmission, serial peripheral interface (SPI), and universal serial bus (USB) according to the present invention employs the SPI communication protocol to realize the switching function, thus the advantages of SPI, including full-duplex, high bandwidth, brief circuit, and simple control are achieved.

What is claimed is:

1. A KVM switcher (multi-computer switcher) with integrated parallel transmission, serial peripheral interface (SPI), and universal serial bus (USB), including:
a SPI master control unit, with a SPI master device interface and a parallel transmission interface;
at least one USB host interface control unit, with an USB interface for connecting the peripheral device of the USB interface, and a parallel transmission interface and a SPI slave device interface for connecting the SPI master device interface of the SPI master control unit, in which the parallel transmission interface of the USB host interface control unit selectively and electrically connects the parallel transmission interface of the SPI master control unit; and
at least one USB device control unit, with an USB interface for connecting at least one USB interface of a computer or at least one USB hub, and a SPI slave device interface for electrically connecting the SPI master device interface of the SPI master control unit; characterized in that signals are transmitted through the parallel transmission interface between the SPI master control unit and the at least one USB host interface control unit.

2. The KVM switcher (multi-computer switcher) with integrated parallel transmission, serial peripheral interface (SPI), and universal serial bus (USB) as claimed in claim 1, wherein the SPI master control unit can switch and select a specific USB device control unit among the at least one USB device control unit, and assign the signal of the at least one USB device control unit to the specific USB device control unit; and the SPI master control unit directly controls the connected SPI slave device through the SPI master device interface to achieve the switch operation.

3. The KVM switcher (multi-computer switcher) with integrated parallel transmission, serial peripheral interface (SPI), and universal serial bus (USB) as claimed in claim 1, wherein signals transmitted between the SPI master control unit and the at least one USB device control unit through the SPI interface.

4. The KVM switcher (multi-computer switcher) with integrated parallel transmission, serial peripheral interface (SPI), and universal serial bus (USB) as claimed in claim 1, wherein the peripheral device of the at least USB interface is a keyboard with USB interface or a mouse with USB interface.

5. The KVM switcher (multi-computer switcher) with integrated parallel transmission, serial peripheral interface (SPI), and universal serial bus (USB) as claimed in claim 1, wherein the at least one USB hub electrically connects the at least one USB device control unit, respectively, and the at least one USB device control unit indirectly electrically connects the corresponding computers through the at least one USB hub.

6. The KVM switcher (multi-computer switcher) with integrated parallel transmission, serial peripheral interface (SPI), and universal serial bus (USB) as claimed in claim 5, further including an USB switch electrically connecting the SPI master control unit and the at least one device with USB interface, wherein the USB switch is controlled by the SPI master control unit, to assign the signal of the device with USB interface to the plural USB hubs.

7. The KVM switcher (multi-computer switcher) with integrated parallel transmission, serial peripheral interface (SPI), and universal serial bus (USB) as claimed in claim 6, wherein the device with USB interface is a storage device with USB interface.

8. The KVM switcher (multi-computer switcher) with integrated parallel transmission, serial peripheral interface (SPI), and universal serial bus (USB) as claimed in claim 1, wherein the SPI master control unit can mutually transfer the signals between the parallel transmission interface and the SPI master device interface.
